(19) United States
(12) Patent Application Publication
(10) Pub. No.: US 2015/0008153 A1
(43) Pub. Date: Jan. 8, 2015

(54) Sectional locking medicine container

(71) Applicant: Brent Bradley Ackerman, Bremerton, WA (US)

(72) Inventor: Brent Bradley Ackerman, Bremerton, WA (US)

(21) Appl. No.: 13/987,149

(22) Filed: Jul. 3, 2013

(51) Int. Cl. A61J 1/03

(52) U.S. Cl. CPC A61J 1/03
USPC 206/538

(57) ABSTRACT

The locking medicine containers with separations are formed in such a manner as to secure medications when an insert is locked in position. The locking apparatus is unique and the materials used are applied in such a way as to benefit the units. The manufacture and assembly of the invention makes it a simple, low cost, quality product that is easy to use. The inserts with three containers, providing two storage areas as well as the separation areas, may all be locked together. Additional storage areas allow the addition of electrical equipment without reducing the locking or storage functions. The opening difficulty raises this invention above the childproof products on the market and is produced with the intent to hinder anyone attempting to take prescription drugs that have not been prescribed to them.

### CROSS-REFERENCE TO RELATED APPLICATIONS

This application is related to Provisional Patent Application No. 61/690,853 filed on Jul. 5, 2012 by Brent B. Ackerman.

### FEDERALLY SPONSORED RESEARCH

None

### SEQUENCE LISTING OR PROGRAM

None

### BACKGROUND-FIELD

This invention relates to sectional medicine containers, specifically to child proof or locking containers.

### BACKGROUND-PRIOR ART

The pharmaceutical packaging field has failed to provide a low cost, quality, locking container that fits the requirements of the food and drug administration. Financial problems, ease of use and security are the major problems. Other problems from various inventors are in this section describing the shortcomings of their products.

The lack of such a product has allowed overdoses, addiction and death to all to many individuals. Family and friends have suffered and the lack of security has many parents worried.

No lock problems—U.S. Pat. No. 8,006,845 by Noble is a sectional container with a slide type retainer meant to hold items secure during transportation but is incapable of locking. U.S. Pat. No. 5,915,560 by George is a multi compartment pill dispenser held together by threads but no lock. U.S. Pat. No. 5,242,076 by Gigilisco is a child resistant unit with a slide-able lid and variable trays that is questionably even child resistant. U.S. Pat. No. 4,572,376 by Wrennall is a multitime medication container with a spinning top, no lock. U.S. Pat. No. 4,334,617 by Rossmo is a pill dispenser with multiple compartments but again no lock. U.S. Pat. No. 4,593,819 by Will, U.S. Pat. No. 5,351,818 by Daneshvar, U.S. Pat. No. 8,136,666 by Goldman, U.S. Pat. No. 5,356,012 by Tang and U.S. Pat. No. 8,132,672 by Ganti are also medical storage devices without locking apparatus.

Cost, size and mobility problems—U.S. Pat. No. 7,731,308 by Riemer is a large hospital type unit without individual capabilities. U.S. Pat. No. 7,917,246 by Handfield is another large, expensive, non individual type unit. U.S. Pat. No. 5,752,621 by Passamante and U.S. Pat. No. 6,330,957 by Bell-Greenstreet are automated pill dispensers not intended for individual use. Agans U.S. Pat. No. 5,159,581 has the same problems cost, size and mobility. Manufacture costs and locking capabilities undue the potential for Corbins U.S. Pat. No. 8,020,415 and the complexity, cost and locking problems of Varvarelis U.S. Pat. No. 7,359,765 undue it as well. Mclaughlins U.S. Pat. No. 4,717,042 needs an accessory locking device, has a high cost and is difficult to manufacture, thus removing it from the market place as well.

None of the previously mentioned inventions have had success in sales for the reasons listed and none of the inventions fill the public need for a safe locking medicine container.

### SUMMARY

In accordance with one embodiment, a sectional medicine container with a strong locking apparatus.

### DRAWING FIGURES

FIG. 1 in perspective view is a four tumbler, locking container with a compartmentalized holding unit inserted in the container.

FIG. 2 in perspective view is a four tumbler, locking container with a compartmentalized holding unit having inwardly accessible storage cavities within each end that is inserted into the container.

FIG. 3 in perspective view is a four tumbler, locking container with a compartmentalized holding unit having caped, outwardly accessible storage cavities that is inserted into the container.

FIG. 4 in perspective view is a square, four tumbler, locking container with a compartmentalized holding unit inserted into a container.

FIG. 5 in perspective view is a square, four tumbler, locking container with a compartmentalized holding unit having inwardly accessible storage cavities within each end that has been inserted into the container.

FIG. 6 in perspective view is a square, four tumbler, locking container with a compartmentalized holding unit having caped outwardly accessible storage cavities that has been inserted into the container.

FIG. 7 is a round, four toothed, compartmentalized insert half shown in perspective view.

FIG. 8 is a round, four toothed, compartmentalized insert half shown in perspective view having inwardly accessible storage cavities.

FIG. 9 is a round, four toothed, compartmentalized insert half shown in perspective view having hollow ends.

FIG. 10 is a round container half given in perspective view.

FIG. 11 is a square, four toothed, compartmentalized insert half shown in perspective view.

FIG. 12 is a square, four toothed, compartmentalized insert half shown in perspective view having inwardly accessible storage cavities and inter changeable partitions.

FIG. 13 is a square, four toothed, compartmentalized insert half shown in perspective view having hollowed ends.

FIG. 14 is a square container half given in perspective view.

FIG. 15 is a round, compartmentalized, four toothed insert given in perspective view.

FIG. 16 is a round, compartmentalized, four toothed insert with inwardly accessible storage areas given in perspective view.

FIG. 17 is a round, compartmentalized, four toothed insert with hollowed ends given in perspective view.

FIG. 18 is a round container with sixteen stator protrusion holes that is shown in perspective view.

FIG. 19 is a square, compartmentalized insert given in perspective view.

FIG. 20 is a square, variable partition insert with inwardly accessible storage areas that is given in perspective view.

FIG. 21 is a square, compartmentalized insert with hollowed ends given in perspective view.

FIG. 22 is a square container with sixteen stator protrusion holes given in perspective view.

FIG. 23 is a four protrusion stator in a perspective view.

FIG. 24 is a four protrusion stator with an alignment mark in a perspective view.

FIG. 25 is a four angles protrusion stator in a perspective view.

FIG. 26 is a tumbler in a perspective view.

FIG. 27 is a tumbler with varying indicia in a perspective view.

FIG. 28 in perspective view is a large threaded cap with a turning means.

FIG. 29 in perspective view is a small threaded cap with a turning means.

FIG. 30 in perspective view is a large rubber plug.

FIG. 31 in perspective view is a small rubber plug.

FIG. 32 is a round partition insert in a perspective view.

FIG. 33 is a square partition insert in a perspective view.

FIG. 34 is a partition insert with a separation wall in a perspective view.

FIG. 35 is a partition insert with two separation walls in a perspective view.

FIG. 36 is a partition insert with three separation walls in a perspective view.

FIG. 37 is a round gasket in perspective view.

FIG. 38 is a large round gasket with an attaching means in perspective view.

FIG. 39 is a square gasket in perspective view.

FIG. 40 is a large square gasket with attaching means in perspective view.

### REFERENCE NUMERALS

#12 hollow
#13 tumbler
#14 stator
#15 large cap
#16 cap
#17 void
#18 indicia
#19 variable indicia
#20 alignment mark
#21a container
#22b square container
#22a insert
#22b insert with inner opening ends
#22c insert with outer opening ends
#22d square insert
#22e square insert with inner opening ends
#22f square insert with outer opening ends
#23 hand grip
#24 storage area
#25 partition
#26 groove
#27 flange
#28 tooth half
#29 concealment tooth half
#30 threads
#31 bump
#32 channel
#33 stator protrusion area
#34 slot half
#35 foot half
#36 foot
#37 rise
#38 indentation
#39 tooth
#40 concealment tooth
#41 slot
#42 reference indicia
#43 changeable partition
#44 stator tooth cavity
#45 protrusion
#46 angled protrusion
#47 turning means
#48 catch
#49 tumbler tooth cavity

### DESCRIPTION-FIRST EMBODIMENT

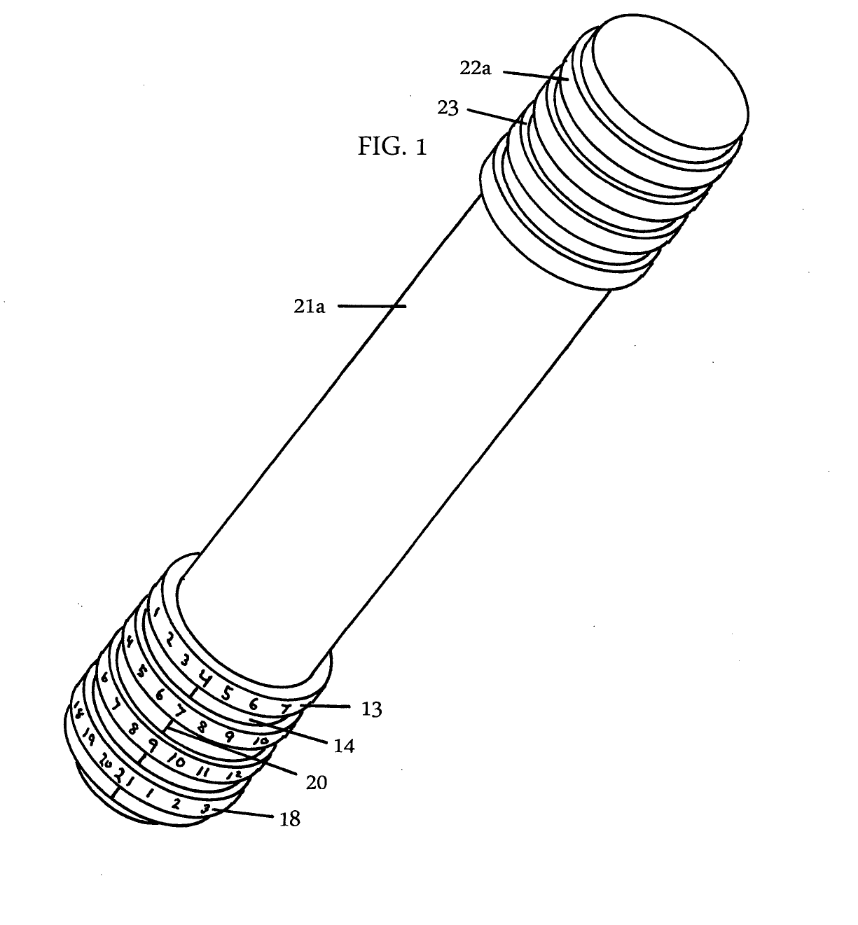

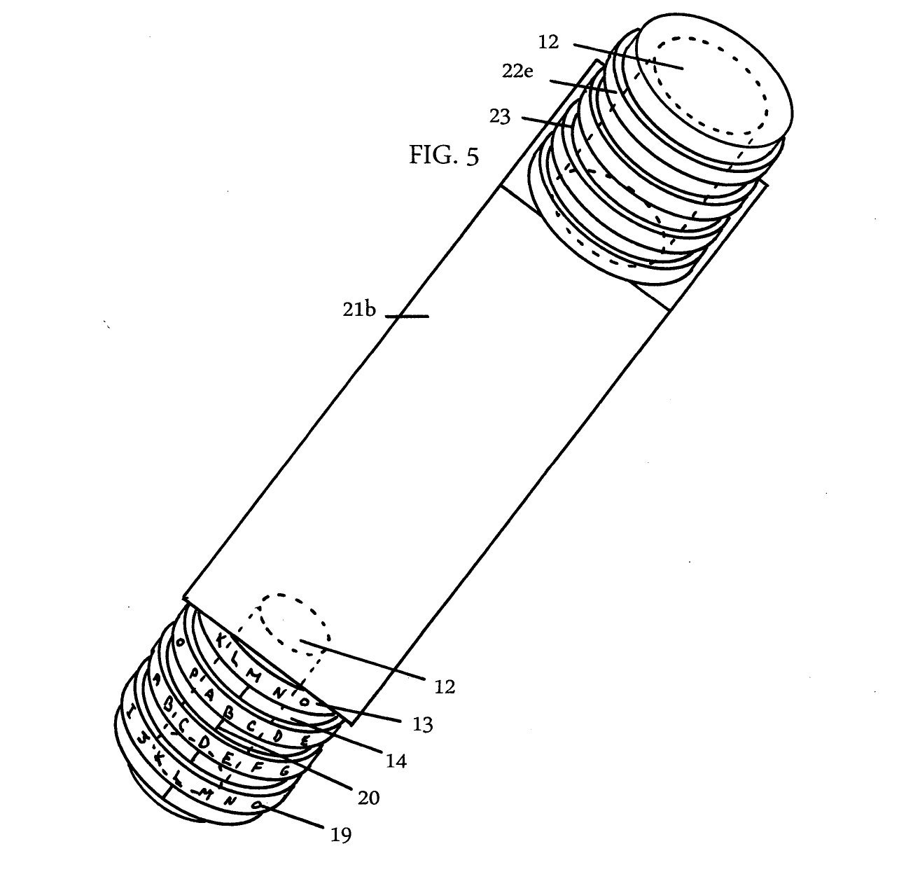

FIG. 1 is a round, four tumbler, locking container with a compartmentalized insert. FIG. 1 is preferably made of polypropylene from molds and an injection molding machine and may be made with the following. An insert 22a made by joining FIG. 7 with its' mirror image through either vibration, thermal or chemical bonding techniques. A container 21a made by joining FIG. 10 to its mirrored image half. And tumblers 13 and stationary parts, stators, 14 that are attached to the locking cylinder.

The insert FIG. 15 made of plastic with a griping area 23, partitions 25, storage areas 24, having reference indicia 42 and locking teeth 39, one of which is a concealment tooth 40. The rise 37 is on the outer wall along with several indents 38 while a foot 36 is at the underside of the insert grip 23. Although there are many parts it is simply made by joining FIG. 7, a one piece part, to its' mirrored image half.

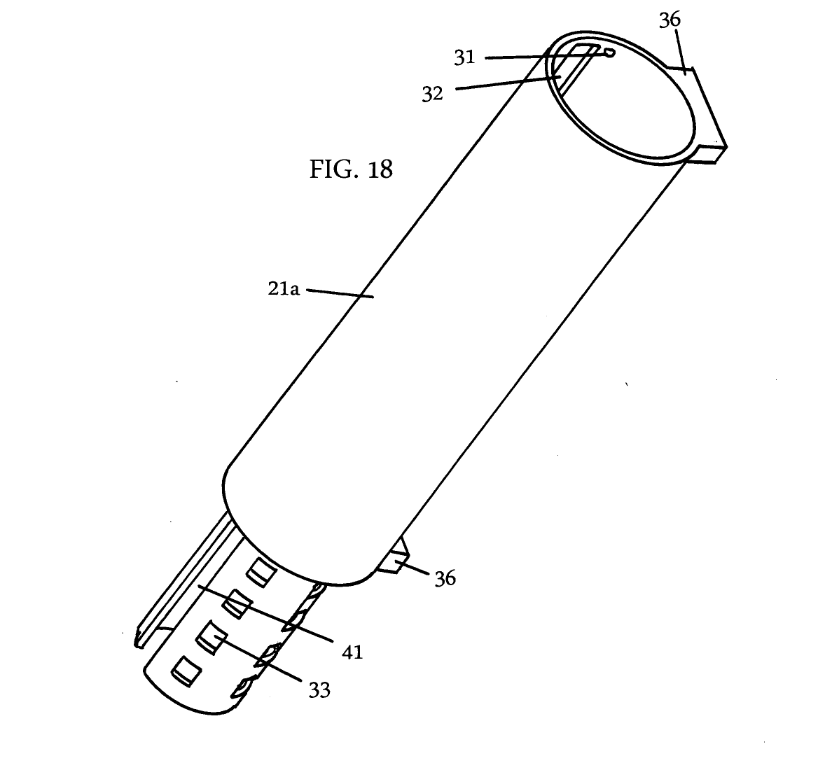

A container 21a is made by joining FIG. 10 which has a channel 32, a bump 31, two foot halves 35, stator insertion holes 33 and a slot half 34 to its' mirrored image half to form FIG. 18 the container. FIG. 18 and all its complexity is made by joining two parts. The tumbler FIG. 26 has a single tooth cavity 49 and indicia 18 on its outer wall and is placed around the locking cylinder located at the end of the container 21a. The stator FIG. 24 has protrusions 45 that hold the tumblers 13 and stators 14 in place when inserted into the stator insertion holes 33. The stator may be marked with an alignment mark 20 for tumbler indicia correlations.

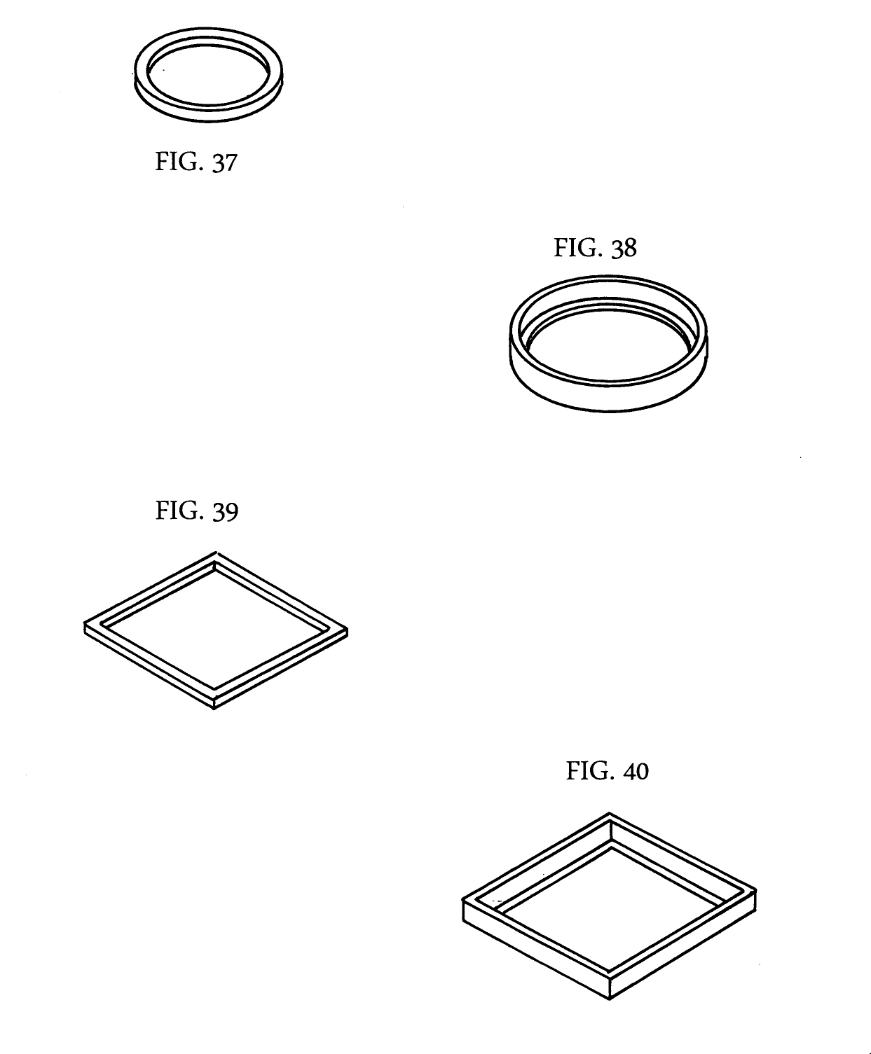

The unit may be labeled, the number of tumblers 13 and stators 14 may vary to change the opening difficulty and gaskets FIG. 37 and FIG. 38 may be added to form a seal. The container 21a and insert 22a may be snapped together with the addition of snap-able components placed on the edges of the insert and container halves. The channels 32 may be on the insert and the bump 31 and indentations 38 reconfigured as well. The stators 14 may be glued or bonded differently, the stator FIG. 25 with the angled protrusions 46 may be used for the manufacture purposes and the number of partitions may be changed or removed altogether. The number of teeth 39 may be changed as well as the tooth placement.

### Operation—

### First Embodiment

The teeth 39 on the insert hold the insert in place when the tumblers tooth cavity 49 is not in alignment with the stator alignment mark 20. Unlocking is done by aligning previously disclosed indicia information on the tumbler 13 with the alignment mark 20. The tumblers 13 may be removed to change the combination buy unlocking and removing the teeth from the locking area and squeezing the sides of the locking cylinder together. The slot size reduction allows the stator 14 to be removed and then tumbler 13 may be removed. This is repeated until all tumblers 13 and stators 14 have been removed. The tumblers 13 can then be reconfigured into a different order and repositioned with the stators 13 to change the combination. This capability may be used when tampering is suspected.

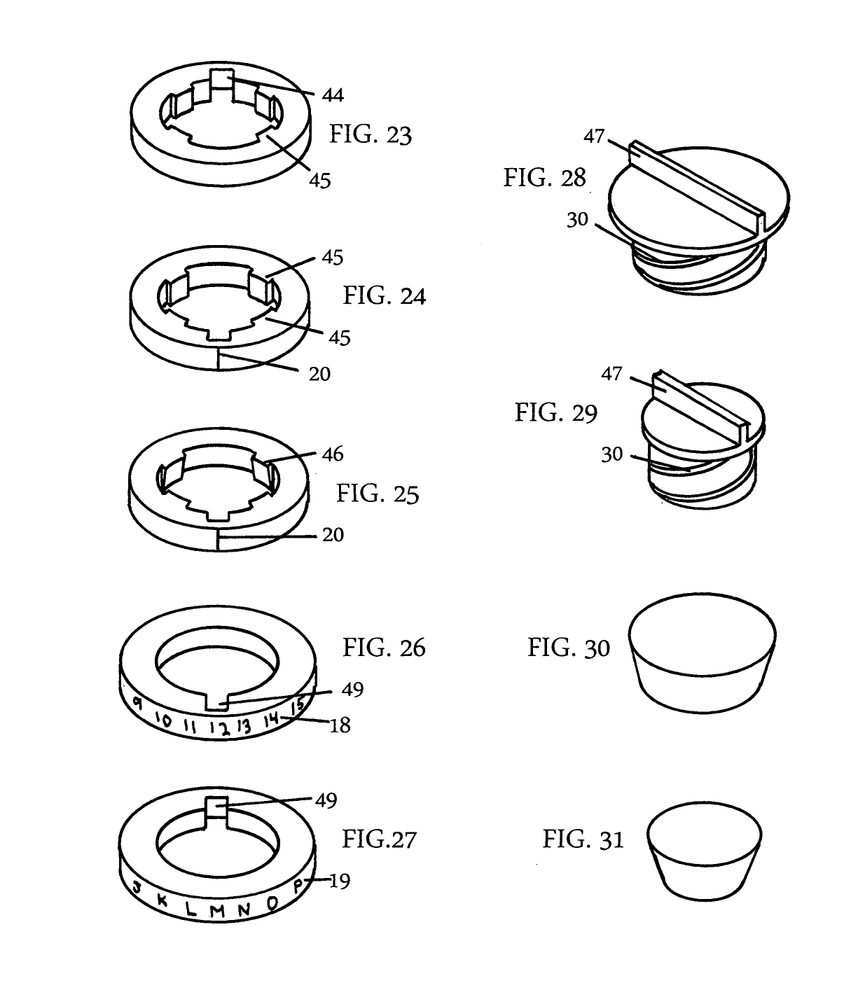

The stators 13 are held in place by the relation between the protrusions 45 and the stator protrusion holes 33. The teeth 39 go through the stator tooth cavity 44, shown in FIG. 23, and the tumbler tooth cavity 49 until fully inserted. When the insert is in the locked position pressing in on the locking cylinder becomes impossible. This inability of the locking cylinder to press in on itself forms and keeps the protrusions in place. This action is the same in all the embodiments of this invention unless glued or thermally bonded.

The gaskets FIG. 37 and FIG. 38 may be applied to form a seal at the inner end of the container between the insert 22a and the container 21a and at the hand grip 23 and container end. The seal is formed when the teeth 39 hold the insert 22a tightly in place. This action may be enhanced by angling the teeth 39 or tumblers 13.

The channel 32 and rise 37 work together to keep the insert 22a in place so the teeth 39 and concealment tooth 40 go into the tooth slot 41 without additional turning. The second function of the rise 37 and channel 32 is to keep the insert 22a in the container 21a. The channel ends stop the rise 37 from going out of the container 21a. Thus holding the insert 22a in the container 21a when fully extended. The bump 31 and indentations 38 work together producing a slight differential in pulling or pushing force. These indentations 38 are located to position the partitions 25 at the container end.

The feet 36 stop it from rolling and upright off the surface, the griping area 23 may be grasped and pulled to open the unit when unlocked. When opened the storage areas 24 may be filled with medication, Pushing the insert 22a in and turning the tumblers 13 locks the insert into the container, Concealment tooth 40 hides the opening location of the outermost tumbler.

### Description—

### Second Embodiment

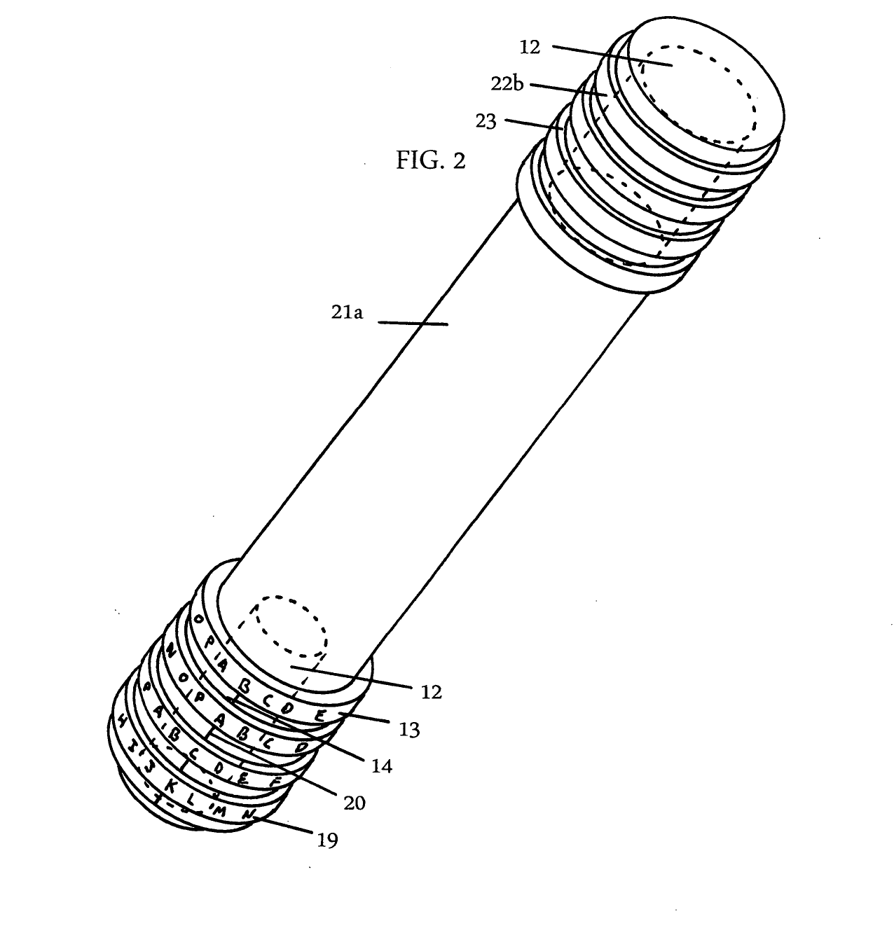

FIG. 2 is a round four tumbler, locking container with compartmentalized areas and storage areas accessible from the inward side of an insert 22b. FIG. 2 is a multipart compilation of an insert 22b, container 21a, tumblers 14, stators 13 and separation part FIG. 32. Clear or colored translucent parts made of plastic as well as solid colored tumblers and stators may be incorporated in the production of this and the other embodiments in this application.

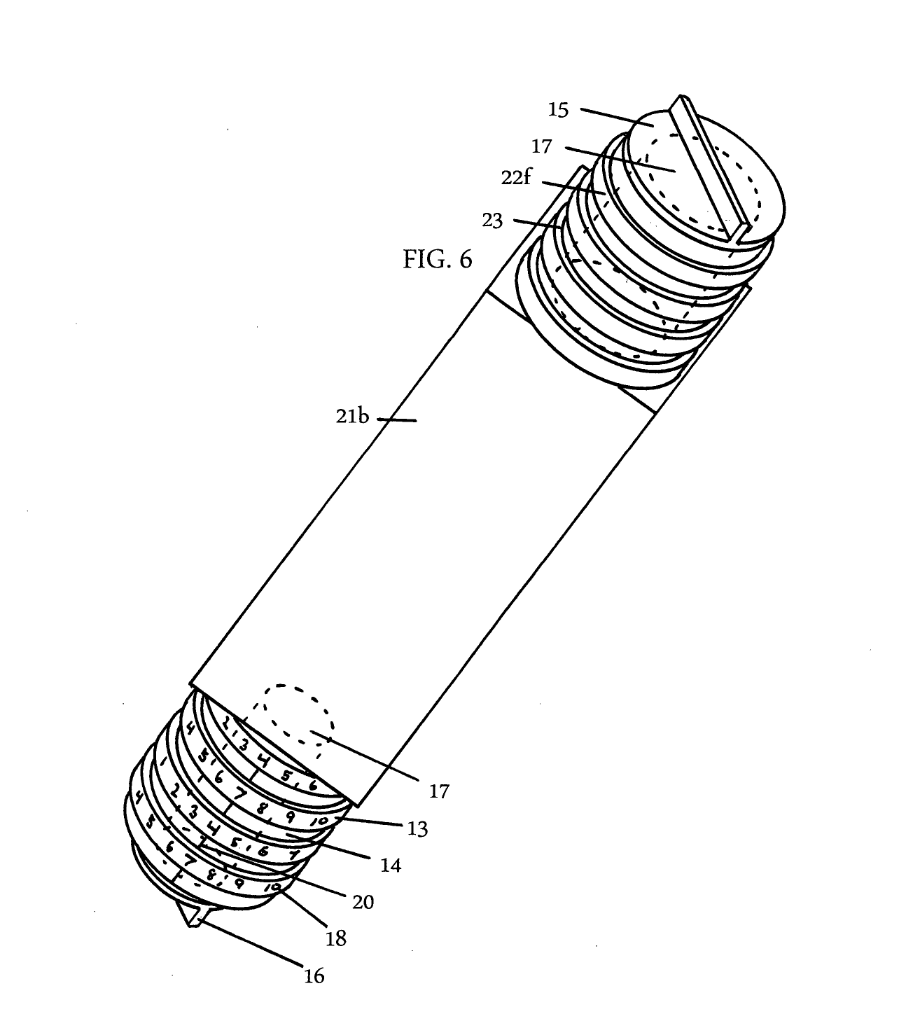

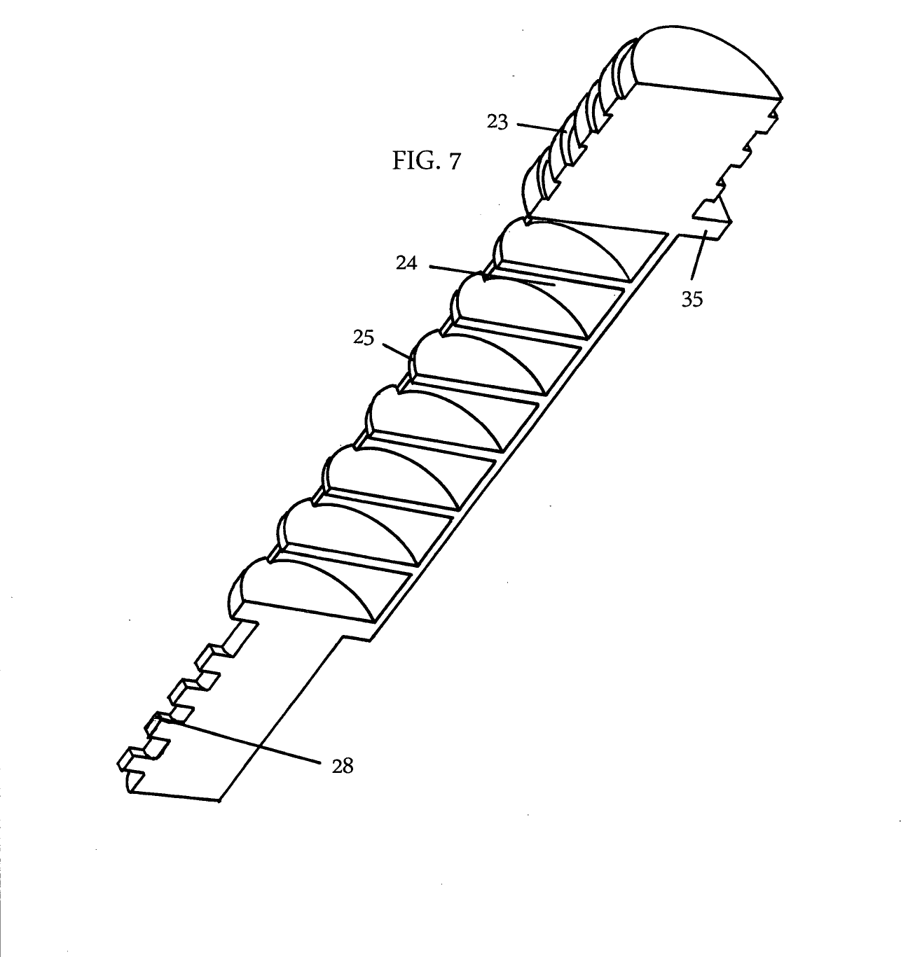

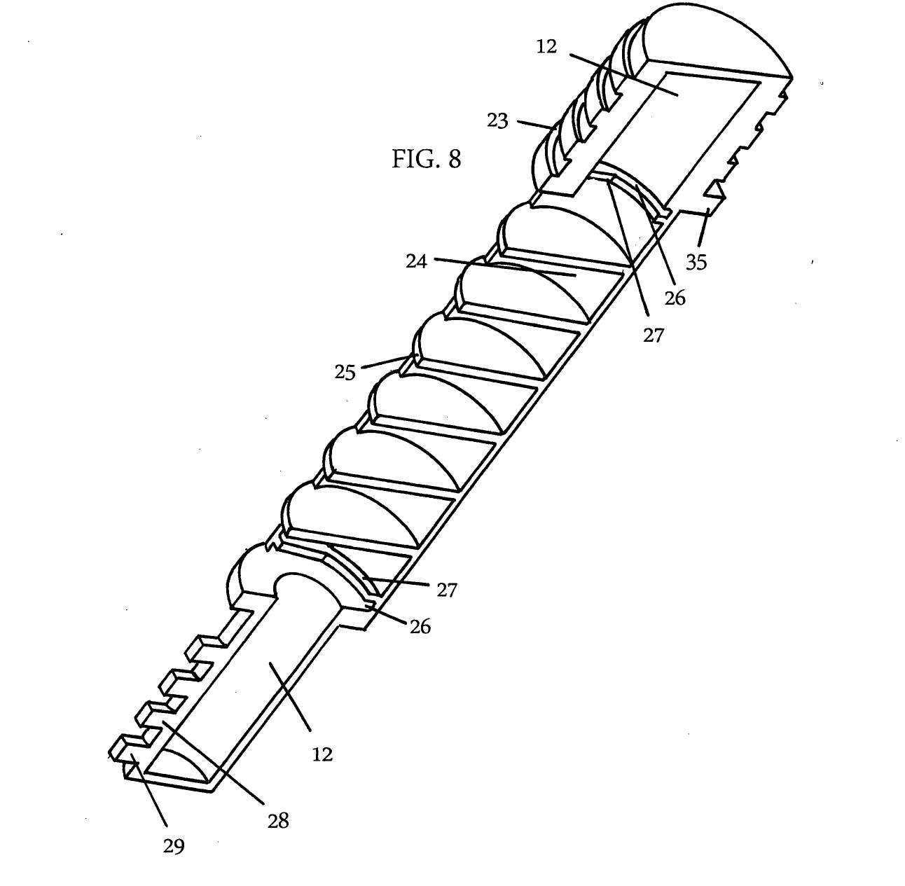

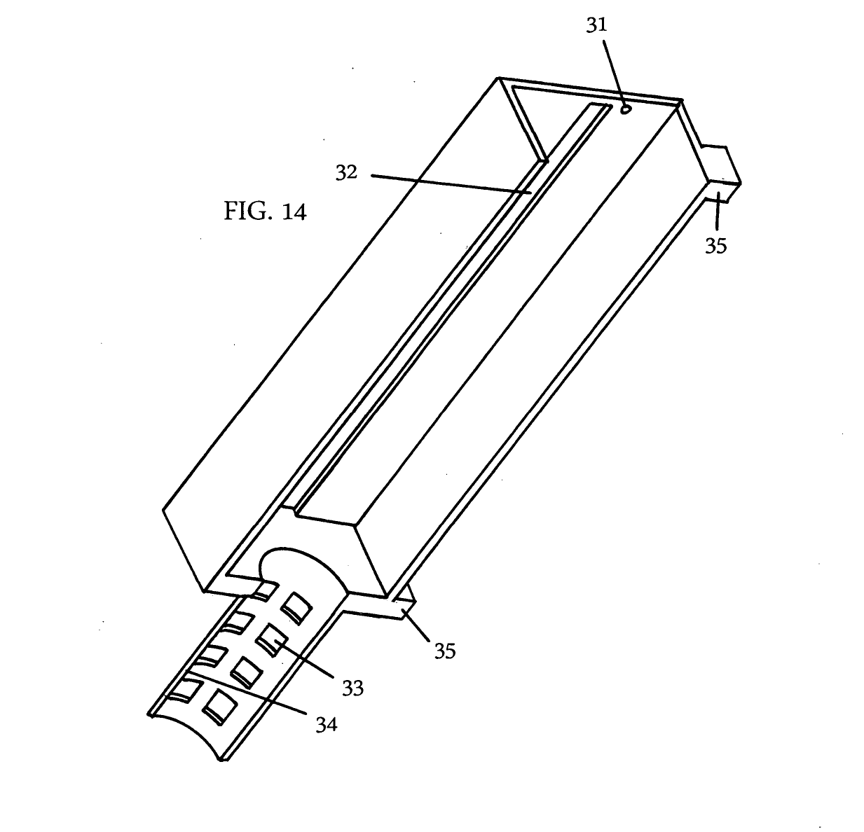

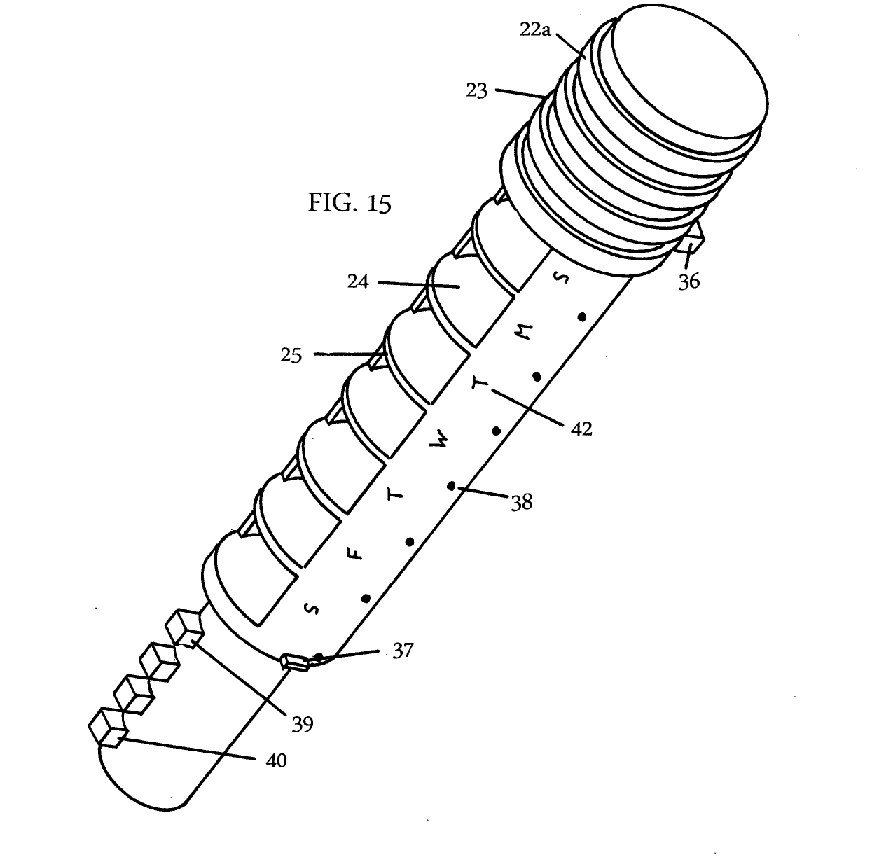

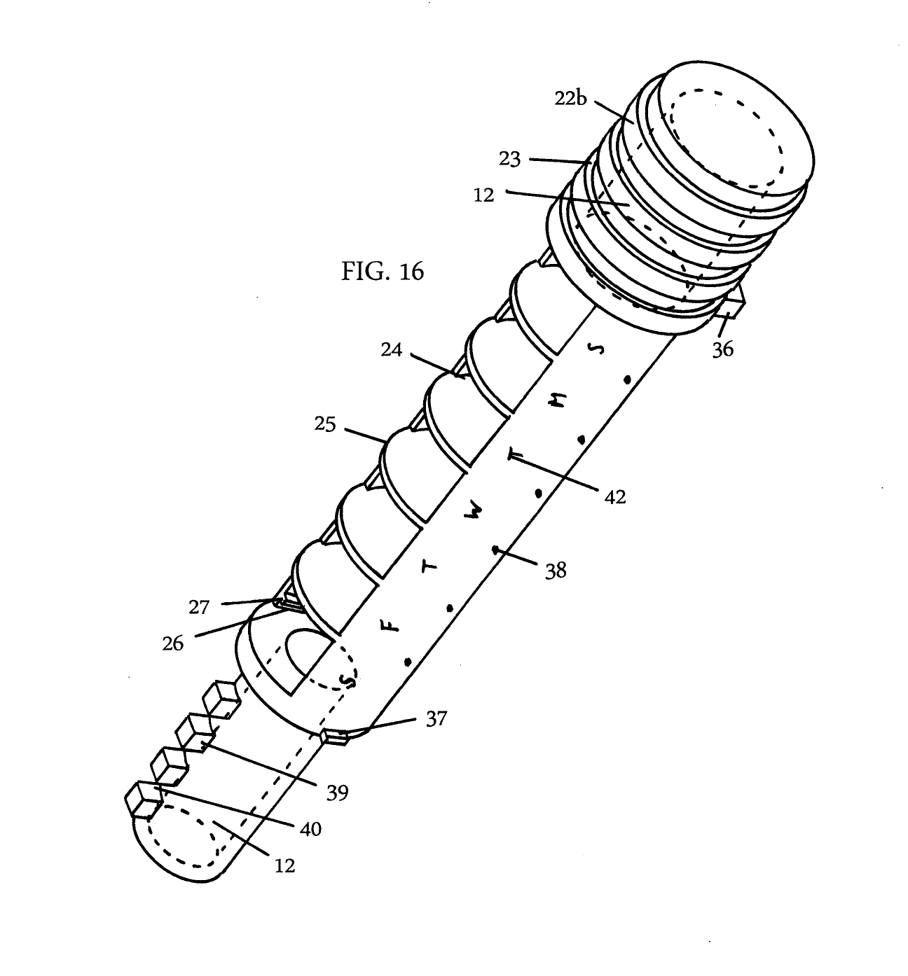

FIG. 16 has a griping area 23, a foot 26, reference indicia 42 with indentations 38 and a rise 37 on the outer wall. The storage areas 24 are divided into sections by partitions 25 and may be identified by corresponding reference indicia 42. The locking apparatus simply has protrusions referenced as teeth 39 and concealing protrusion or tooth 40. The outer ends have hollows 12 made into separate containers by removable partitions FIG. 32 placed within a grove 26. The insert 22b is made by joining FIG. 8 a sectional insert half with enclosed hollowed ends 12, a groove 26 and a flange 27 at each end and teeth halves 28 and concealment tooth half 29 with a mirror image and adding the partitions FIG. 32.

The container is shown as FIG. 18 which has been previously described in the first embodiment. The addition of the tumblers FIG. 27 with varying indicia 19, and stators 14 to the container may be accomplished by pressing together the tooth slot 41 and positioning the parts in there respected positions. The use of FIG. 25 a stator 14 with angled protrusions 46 allows a manufacturer to press all tumblers 13 and stators 14 into place directly.

Triple container capabilities are the bases for this embodiment. The information is not given to limit this invention but to provide a variation of the first embodiment. Other variations are given in the following sentences. The hollows 12 may be solid at either end and the unit may be labeled. The unit may be sealed by placing FIG. 37, a gasket, within the container FIG. 18 at its innermost point and attaching another gasket FIG. 38 to the outer end. The container 21a and insert 22b may be clipped together with hook type latch systems. The channels 32 and bump 31 may be on the insert 22b and the indentations 38 and rise 37 on the container 21a. The stators 14 may be glued or melted into place. The separation may be removes and the reference indica 42 removed. The teeth 39 may be removed or added according to the variable number of tumblers 13 and stators 14.

### Operation—

### Second Embodiment

The operation and assembly of this embodiment is the same as the first embodiment with the following exceptions. Inserting the separator FIG. 32 into the grove 26 and flange 27. These parts produce two additional containers within the insert 22b when inserted. The partition FIG. 32 simply slides into place and the catch 48 aids in the removal of the partition when used. When the partition FIG. 32 is removed contents may be placed within a hollow 12. The contents held in the hollow 12 may be removed when refilling the multiple sections within the insert 22b.

### Description—

### Third Embodiment

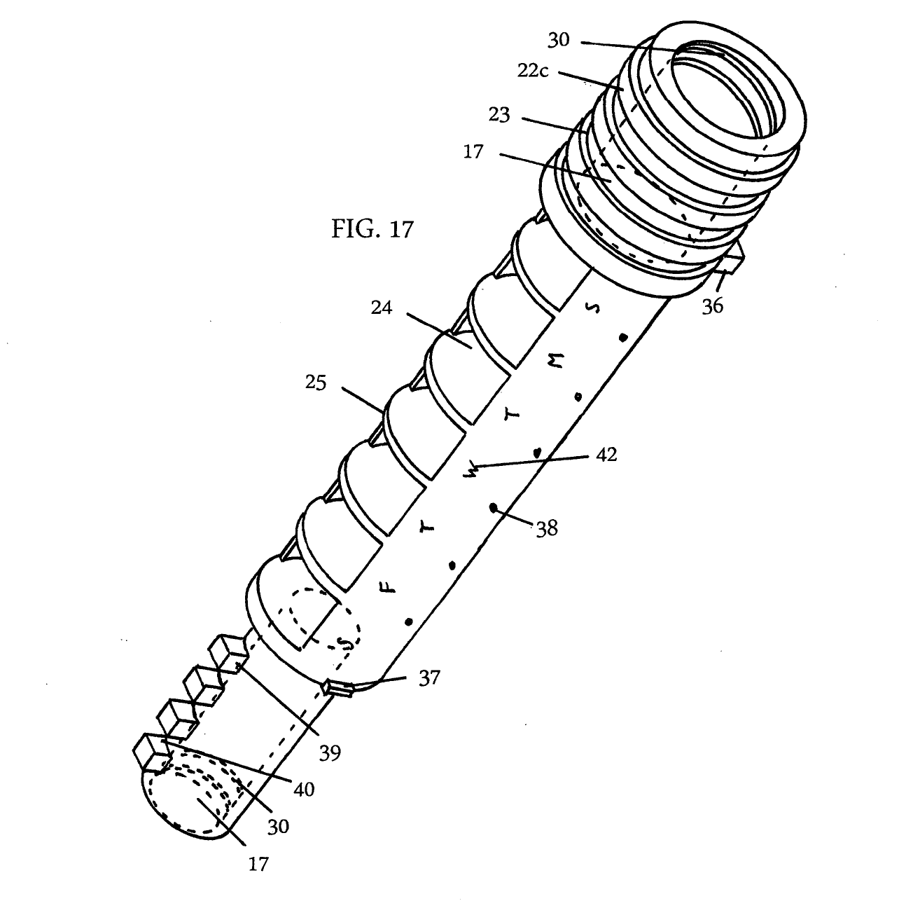

FIG. 3 is a round, four tumbler, locking container with separations within an insert 22c that is caped at the voids 17 within each end. FIG. 3 is assembled by pushing an insert 22c into the container 21a where the rise 37, shown in FIG. 17, sets within the channel 32. The stators 14 and tumblers 13 are positioned in the locking area and caps 15 and 16 are threaded into place enclosing the voids 17.

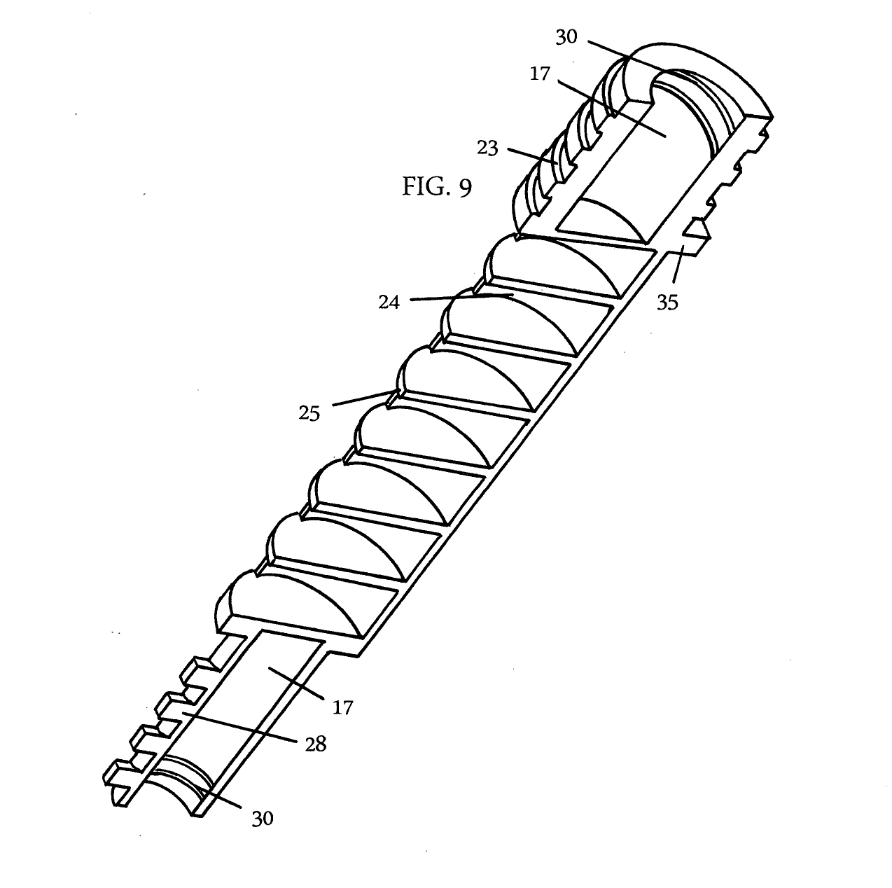

The insert FIG. 17 is made by joining FIG. 9, an insert half with separations, locking teeth halves 28 and threads 30 at the voided ends to its mirrored image. Shown as FIG. 17 the complete insert has threads 30 within the void area 17 for cap insertion. The foot 36 is part of the griping area 23 on the outer side of the void area 17. The separations 25 divide storage areas 24. The reference indicia 42 may be formed when molded on the wall of the insert 22c. Indentations 38 are aligned with a bump 31 in the container 21a disclosing opening information when moved within the container FIG. 18. Two protrusions or feet 36 are positioned on the outer wall of the container 21a.

Electronic equipment may be placed in the voids 17 and sealed with a cap, threaded into the void areas 17 or glued as to allow displays, buttons, microphones and speakers on the outer edge of the inserted equipment. There may be an electrical adapter for rechargeable batteries as well. Threaded electronic inserts may be best for battery type configurations. Transceivers, CPU, processors and other components may also be introduced within the unit.

The voids 17 in the outer ends of the insert 22c are only part of this embodiment. The electronic applications are paramount and are not to be limited in this embodiment. The electronic proprietary applications in the sixth embodiment pertain to this section of this application.

This embodiment may be a combination of the previous embodiments. Either end may be solid or an inner opening container. The quick access into the outer containers may be preferred by many in need of immediate medications. The ends may be filled with water for immediate use or stored. The unit FIG. 3 may be labeled and the number of stators 14, tumblers 13 and storage areas 24 may vary. Seals FIG. 37 and FIG. 38 may be added. The container 21a may be snapped together. The insert 22c may snapped together. The channel 32 and rise 37 may be on the insert 22c and the indentations 38 reduced to one side. The stators 14 may be glued. The partitions 25 may be removed. Teeth may be added to the other side of the insert 22c. Snap on caps may be used in place of threaded caps FIG. 28 and FIG. 29 or rubber caps FIG. 30 and FIG. 31. The partitions 25 may be removed and the area sealed with the exception of one end to form a single container.

### Operation—

### Third Embodiment

The operation of this embodiment is the same as the first embodiment with the following exceptions. The ends are opened from the outside and electrical components, water or medication may be inserted. The caps FIG. 28 and FIG. 29 are removed by turning a raised portion or turning means 47. Information may be placed within the electrical equipment to alarm the owner of medication times etc. Information may be transmitted to and from outside sources and refills provided from a pharmacy. The unit FIG. 3 may also notify health care personnel and place emergency calls through incorporated systems. A motion device may be inserted within the ends that when moved activates an alarm.

### Description—

### Forth Embodiment

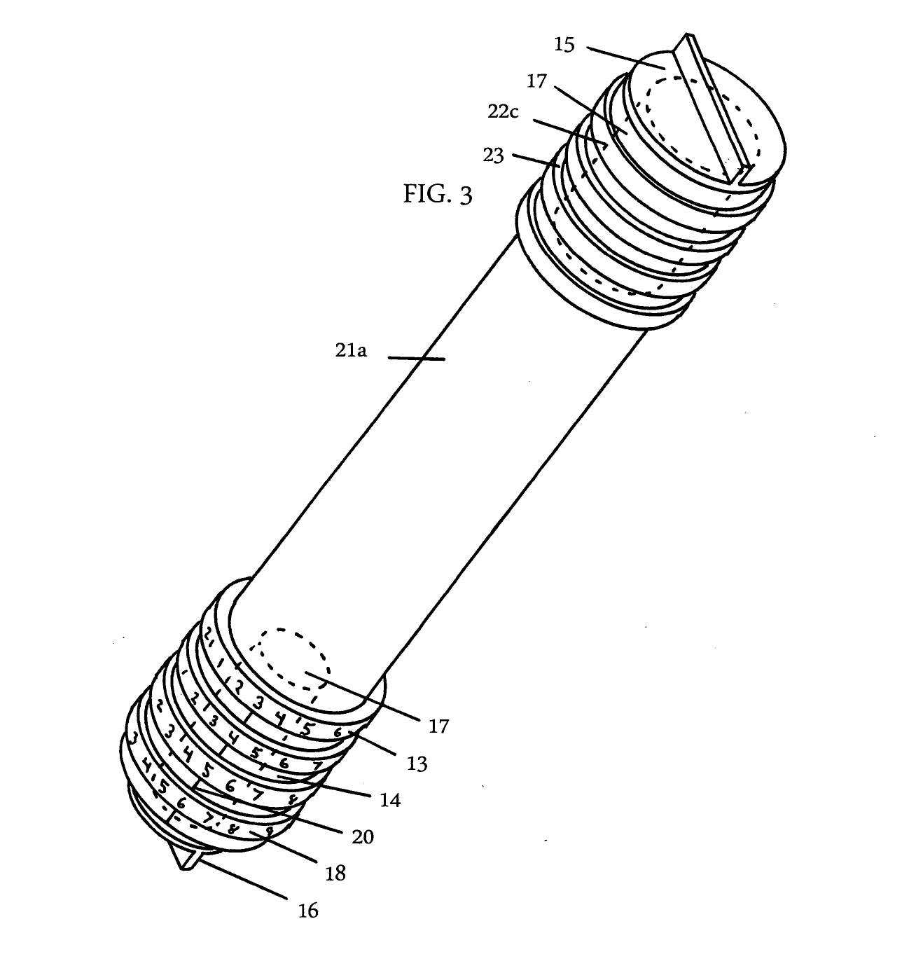

FIG. 4 is a square, four tumbler, locking medicine container having separations within an insert 22d. The insert 22d is inserted into the container 21b and four tumblers 13 and four stators 14 are attached.

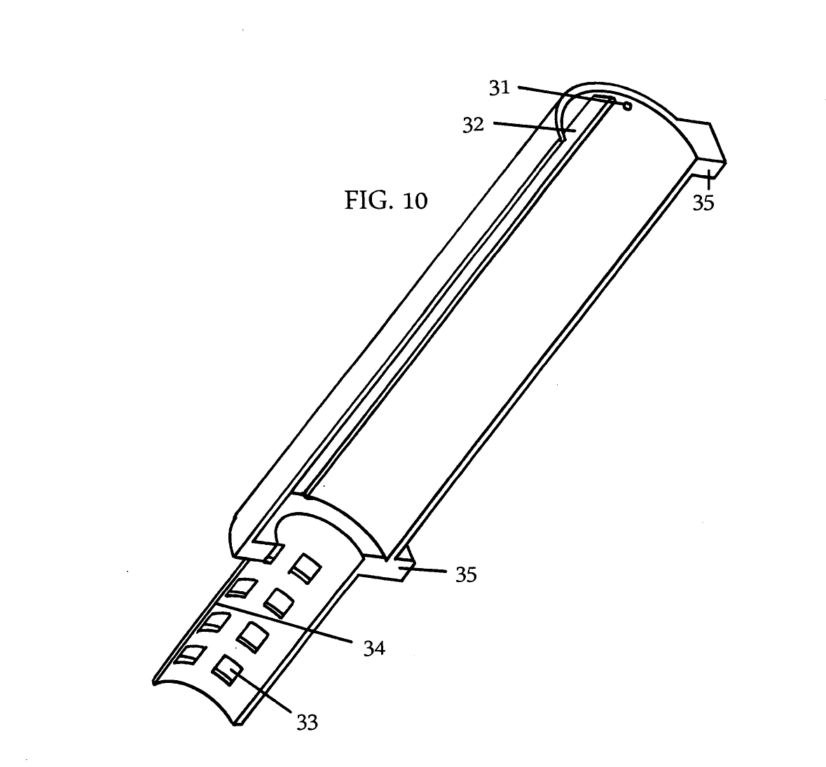

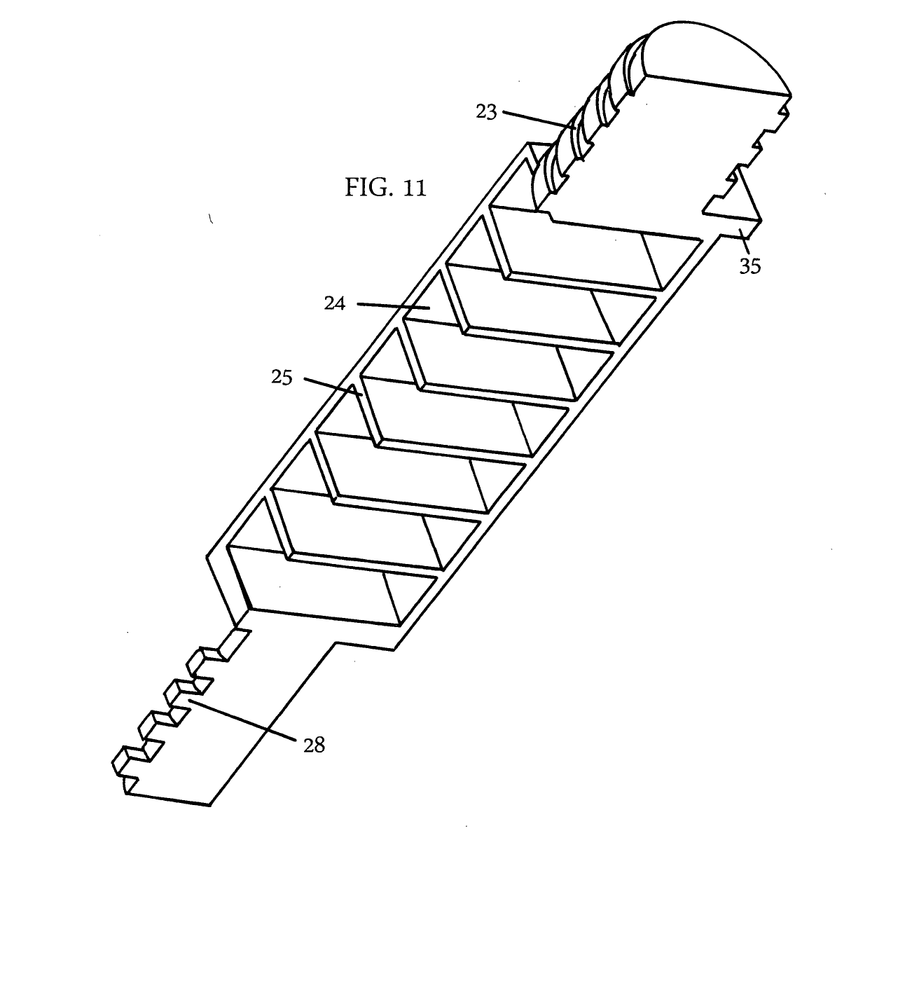

The insert FIG. 19 having storage areas 24, partitions 25, reference indicia 42, rises 37 on two sides, indents 38 on two sides, three locking teeth 39 and a concealment tooth 40 is made by joining an insert half FIG. 11 to its mirrored image half. The insert 22d in this embodiment may be produced with one mold and finished separately. This manufacture capability defines this embodiment.

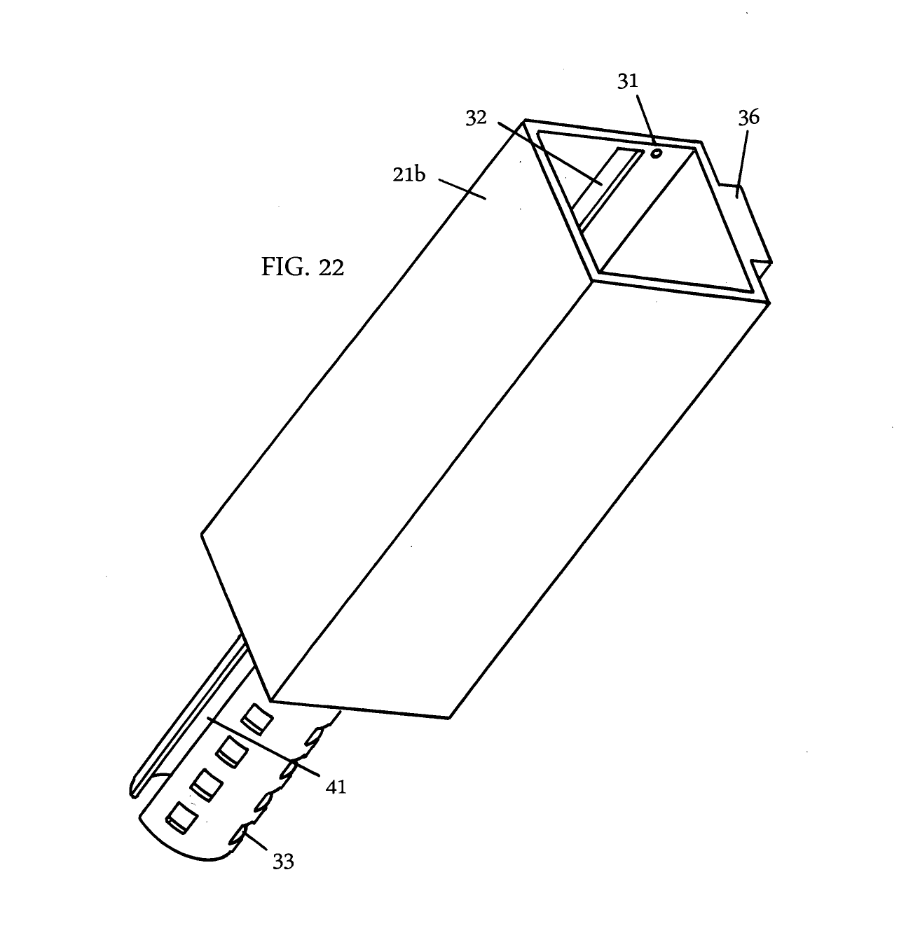

The container FIG. 22 is made by joining a channel 32, bump 31, foot halves 35, stator protrusion areas 33 and a slot half 34 shown as FIG. 14 to its mirrored half.

FIG. 4 may be labeled, the number of tumblers 13 may vary, the number of stators 14 may vary, the number of storage areas 24 may vary and rubber seals FIG. 39 and FIG. 40 added. The container 21b and insert 22d may be snapped together with hook type latches. The channels 32 may be on the insert 22d and the number and location of indents 38 varied. The stators 14 may be glued to the locking cylinder. The partitions 25 may be removed and the space covered to create one container with an opening at one end of the insert. Teeth 39 may be added to the insert 22d to increase the opening difficulty.

### Operation—

### Forth Embodiment

The operation of this embodiment is the same as the first and second embodiments with the following exception. The shape of the container is varied for manufacture.

### Description—

### Fifth Embodiment

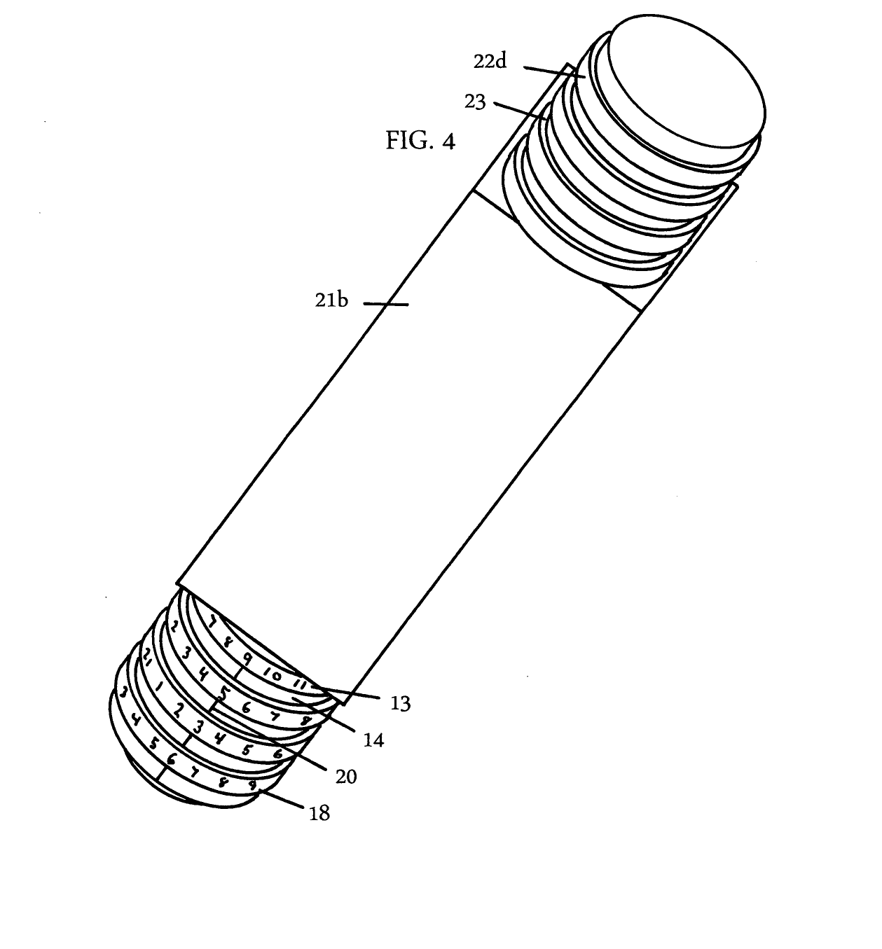

FIG. 5 is a square, four tumbler, locking container with inwardly accessible cavities within each end of an insert 22e. The tumblers 14 and stators 13 are attached and an insert FIG. 20 with hollows 12 within the insert is placed within the container 21b.

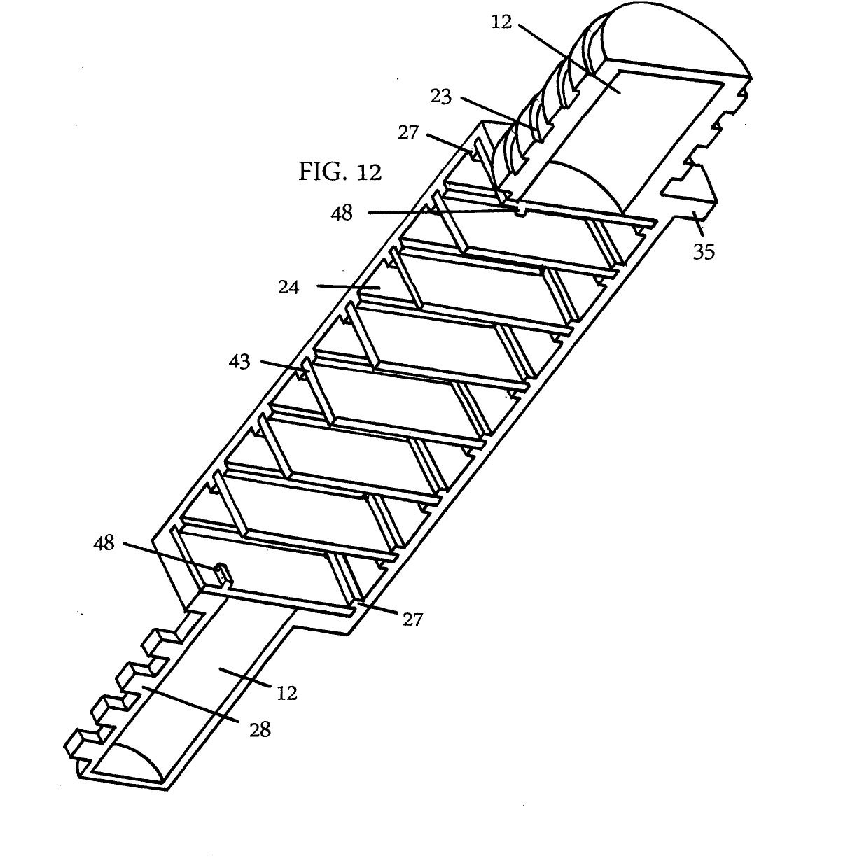

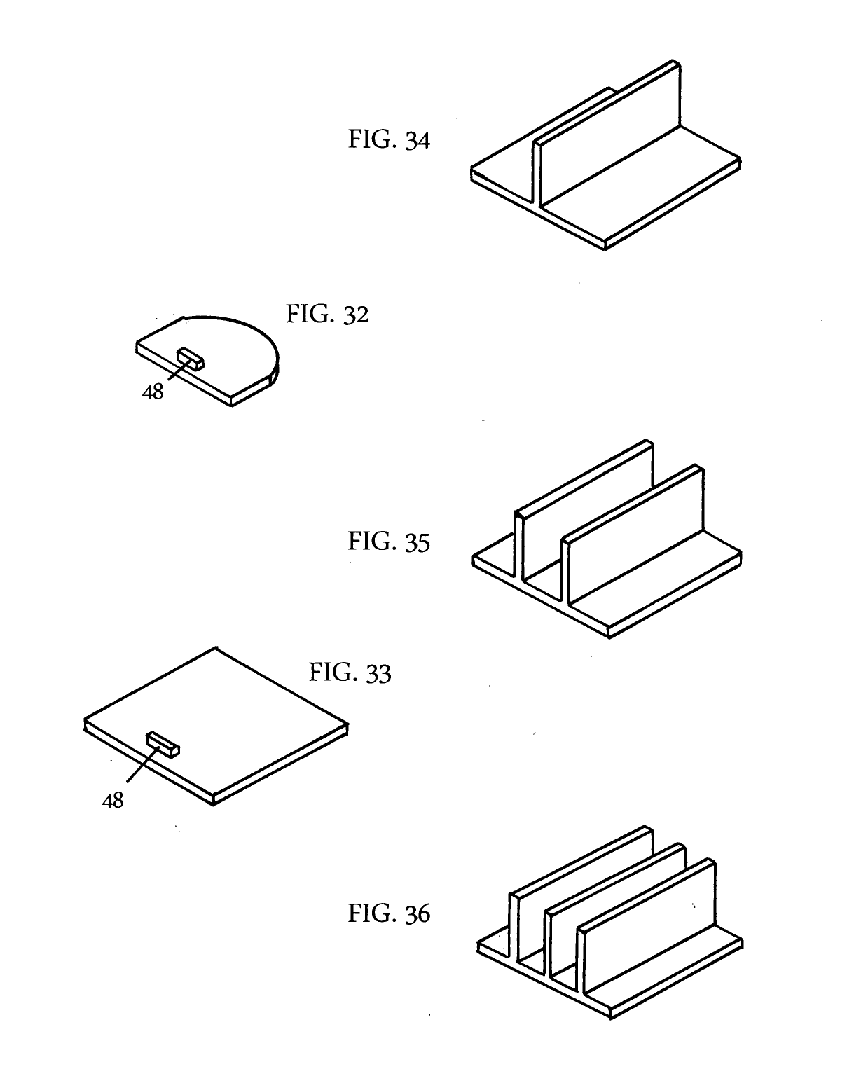

An insert half FIG. 12 having grooves 26 and flanges 27 for partitions 25 is joined to the mirrored half to form FIG. 20. An insert FIG. 20 having hollows 12 varies from the other inserts by the incorporation of removable partitions 43. The width of the insert 22e and container 21b may be increased and a partition with a separation wall FIG. 34 may be added. Other partitions with separation walls FIG. 35 having two, and FIG. 36 having three, may also be used for varying applications. Caps may be introduced to the top of the partitions to aid in dispensing. The catch 48 aids in the movement of a partition FIG. 33 allowing access to the hollows 12.

The unit FIG. 5 may be labeled, the number of tumblers 13 may vary, the stators 14 may vary and the number of partitions 43 may vary. The movable partitions 43 may be fixed. Either end may be solid and electrical components may be installed. Variable storage capabilities, one changeable and two separate, define this embodiment. Seals FIG. 39 and FIG. 40 may be added. The container 21b and insert 22e may be snapped together. The channels 32 may be on the insert and the indentations 38 may be removed. The stators 14 may be glued or thermally bonded and the angled protrusion stators FIG. 25 used in this and other embodiments.

### Operation—

### Fifth Embodiment

The operation of this embodiment is the same as in the first and second embodiments with the following exceptions. The container is square, gaskets FIG. 39 and FIG. 40 are used to form a seal, the partition 43 may be removed and other partitions may be inserted.

The square container may be wider than the shown perspective view allowing the insertion of partitions with additional walls. These partitions FIG. 34, FIG. 35, and FIG. 36 may be used by removing the partition FIG. 33 and other changeable partitions 43 and inserting the multiwall partitions into the groove and flange areas. The partition FIG. 34 produces two separate chambers when inserted next to another partition, FIG. 35 produces three and FIG. 36 produces four. This action may be repeated to produce a wide range of chambers within the insert. And the top of the multiwall partition container may be topped with a sliding part to hold contents within the storage areas created by the multiple walls.

### Description—

### Sixth Embodiment

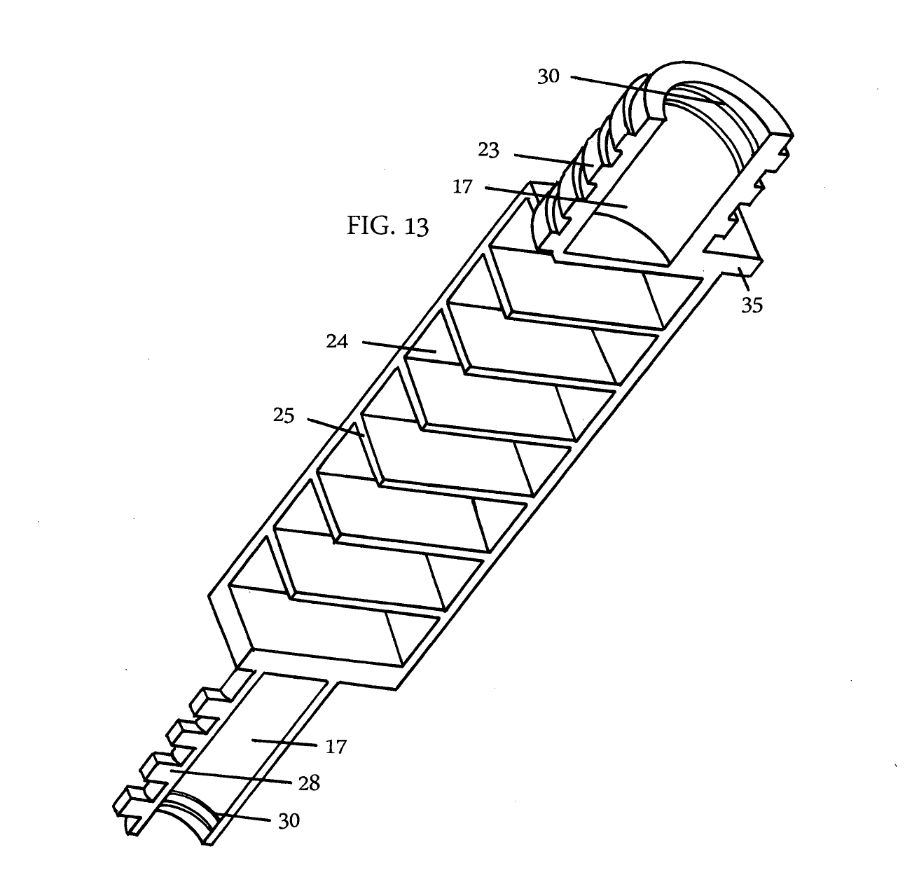

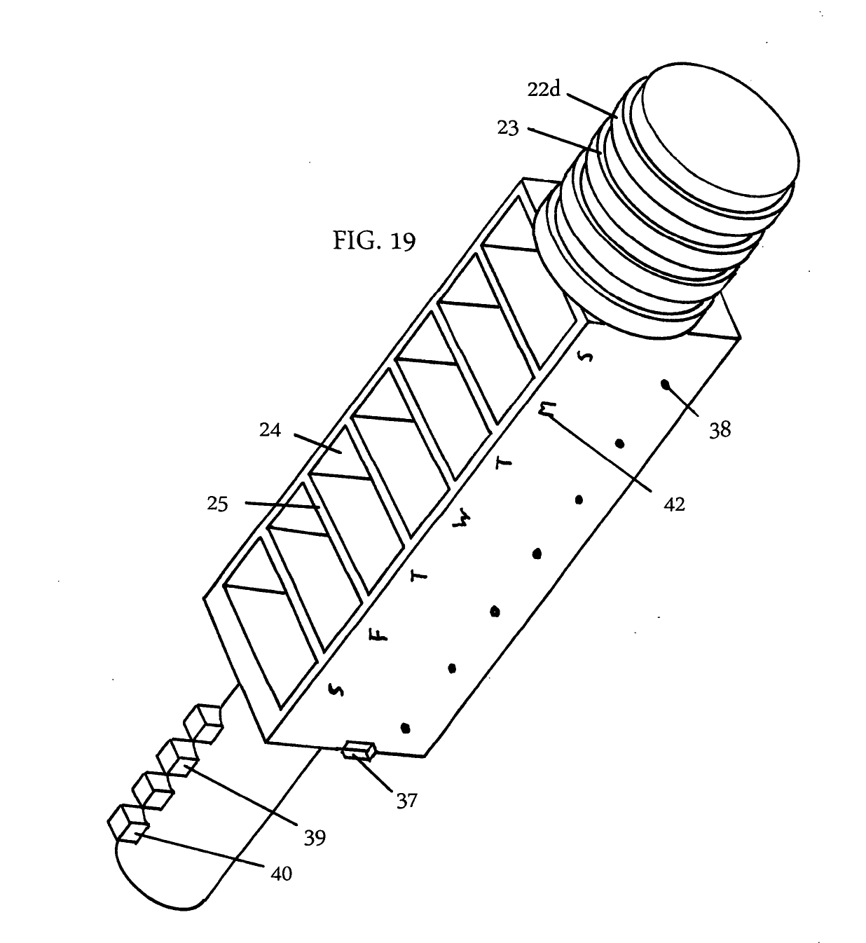

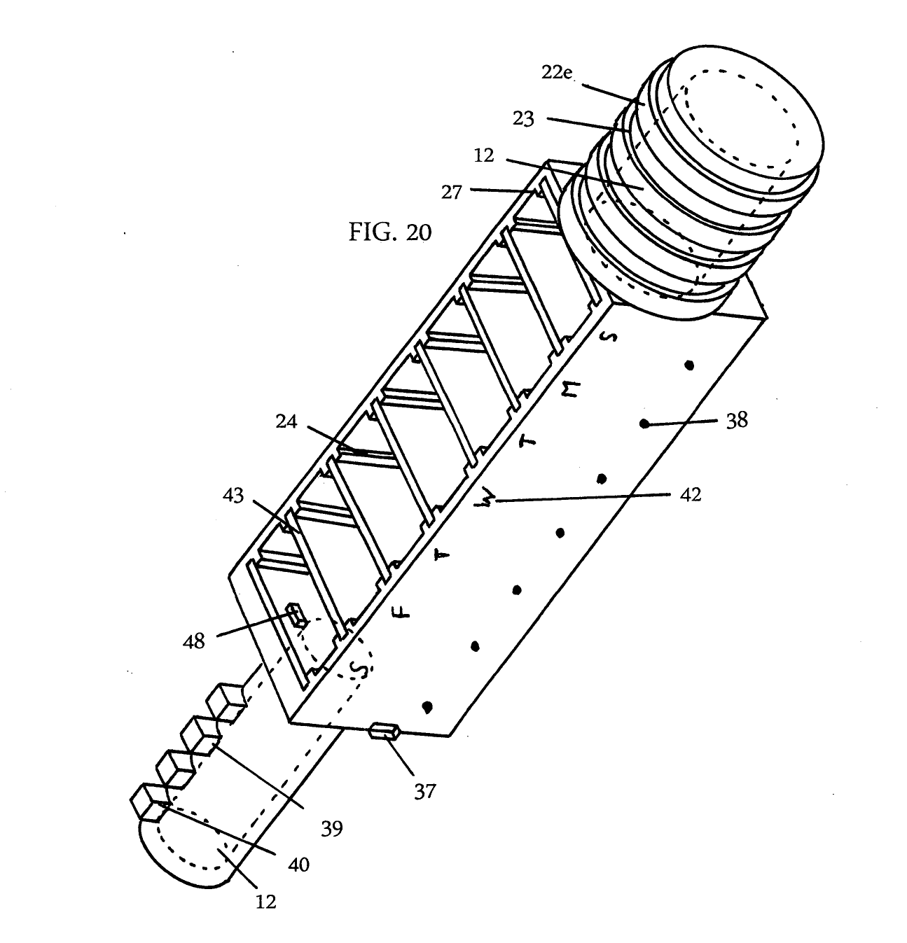

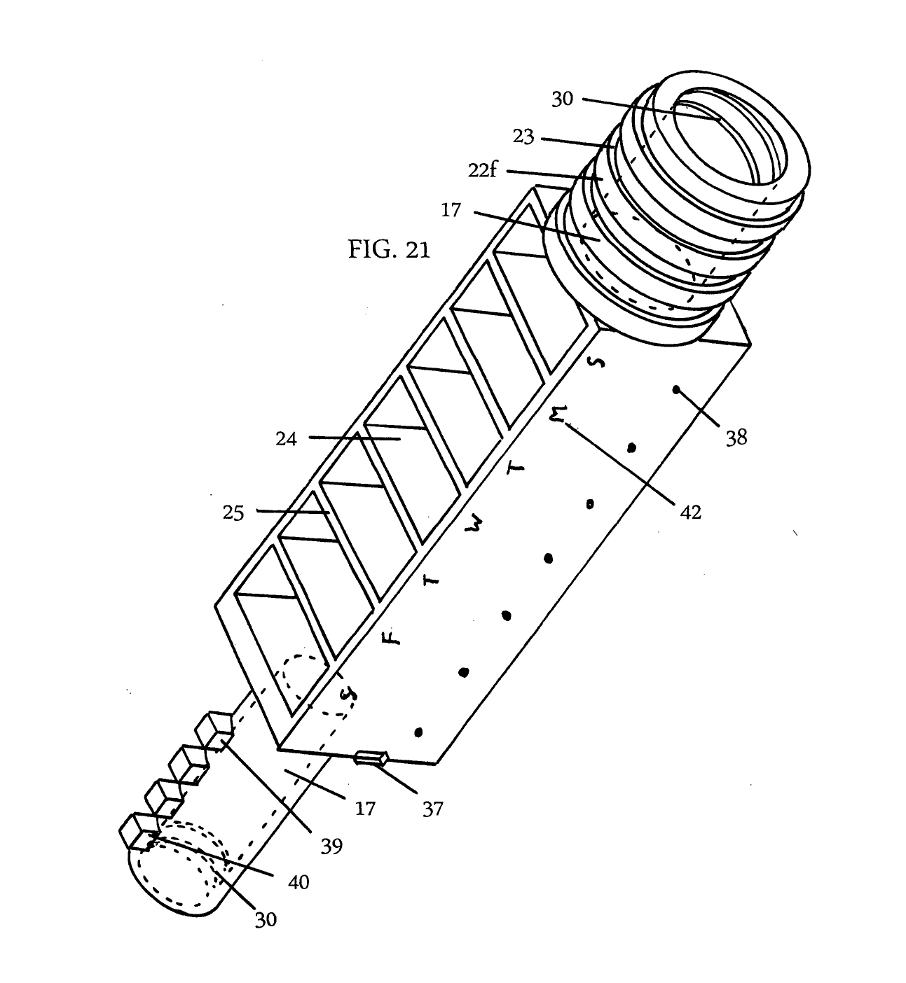

FIG. 6 is a four tumbler, locking container with a compartmentalized holding area having caped outwardly accessible storage areas. The tumblers 13 are attached around a cylinder and are held in place by stators 14. The stators 14 snap in place from protrusions 45 being inserted in a stator protrusion area 33. The insert FIG. 21 has several threads 30 at the voided ends 17 that may be made by an injection molding machine in two parts and joined. An insert half FIG. 13 having storage areas 24, reference indicia 42, indentations 38, locking apparatus, threads 30 and voids 17 at the ends is joined with its mirrored image to produce an insert FIG. 21. A container FIG. 22 is made using the same techniques with a container half FIG. 14.

Electronics may be added at the ends of the inserts to perform new and old proprietary functions. Including but not limited to transmitters, transformers, receivers, displays, batteries, rechargeable batteries, input mechanical devices, speakers and microphones, computer processing units, microchips etc. The functions of which are limitless in potential and may not be described in one embodiment of any certain application.

The number of tumblers 13, the number of stators 14 and the number of teeth 39 may vary and the separations may vary. The unit FIG. 6 may be labeled. Tumblers 13 may have different indicia numbers for an increase or decrease in opening difficulty. The ends may be used for water storage and quick access. Seals FIG. 39 and FIG. 40 may be added. The container 21b and insert 22f may be snapped together. The channels 32 may be on the insert 22f and the channels 32 indented so the rise 37 catches in the channel at different locations. Other embodiments may favor this catch in the channel system as well. The stators 14 may be glued or thermally bonded. The partitions may be reconfigured or removed all together. Separate, removable, changeable partitions may be incorporated into this embodiment. The multistorage area may be covered with an opening at one end to produce a single container with two outwardly open-able containers.

### Operation—

### Sixth Embodiment

The electronics previously described may be assembled as to perform new and useful functions. The functions relating to this patent application are associated with telecommunications, the transmission of varying frequency from the insert sent to and from adapted telephones or computers etc. These may alert medical centers with previously given information to aid those in distress. A push button type end with a transmitter and battery may work well for this. Hopefully an internet website will be manifested as to notify the prescribed user through an electrical insert advising them as to when to take their medication. This site may also inform them as to refill times, doctor appointments and certain medication information. Intercom systems may be added to allow communication to and from health care providers. A transceiver, speaker, microphone, button and battery may work well for this application.

The operation of FIG. 6 is the same as previously described in the first embodiment with the exception of the electronics and open-able ends. The adaptation of the fifth embodiment with the separation variations may be applied to this embodiment as well. Many different electronic configurations may be produced and inserted within these units. The examples given are proprietary and may be applied for in a different application when fully developed.

### CONCLUSION, RAMIFICATIONS AND SCOPE

The products described in this application are easy to produce, inexpensive and produce a great effect on society. The need for products like this couldn't be greater and the variety of embodiments allow it to become a personalized medication container, something previously unheard of. The products presently in the field do nothing for the public need to secure their medication. This lack of securing devices on the market has caused millions to suffer from addiction, theft and eave death. This product can secure medications and reduce the number of stolen medication significantly. This will lesson the number of addicted individuals that become addicted through theft of medications and most of all reduce the number of deaths caused by unsecured medications.

Although the description contains precise information it should not be construed as limiting the scope of the embodiments but as merely providing illustrations of some of the presently preferred embodiments.

I claim:

1. A sectional locking container comprising:
a. holding compartment with multiple sections
b. said locking container having the capability to hold locking components
c. tumblers
d. a tumbler holding means by which attachment and securement are performed by protruding parts being inserted into the locking portion of the container,

2. the holding compartment of claim 1 wherein said holding compartment is made of sterilized, non-corrosive material,

3. said container of claim 1 to be of a translucent material,

4. said locking container of claim 1 to have channels or rises for insert alignments into the locking apparatus,

5. a container insert having outwardly or inwardly open-able containers on either or both ends of the insert,

6. said insert of claim 5 having areas within said insert for electrical components,

7. said insert of claim 5 to have a bump or indent to stop the insert at a desired location,
